(19) United States
(12) Patent Application Publication
(10) Pub. No.: US 2026/0260071 A1
(43) Pub. Date: Sep. 3, 2026

(54) AI/ML CENTRIC DATA EXTRACTION FROM REMITTANCE DOCUMENTS

(71) Applicant: JPMorgan Chase Bank, N.A., NEW YORK, NY (US)

(72) Inventors: Ananthakrishnan Radhakrishnan, Bangalore (IN); Rajan Aditya, Bengaluru (IN); Mihir Mirajkar, New Jersey, NJ (US); Dana Bolton, Chicago, IL (US); Nedim Harbas, Chicago, IL (US); Alex Astle, Jersey City, NJ (US)

(73) Assignee: JPMorgan Chase Bank, N.A., NEW YORK, NY (US)

(21) Appl. No.: 19/179,962

(22) Filed: Apr. 15, 2025

(30) Foreign Application Priority Data
Mar. 3, 2025 (IN) 202511018500

(51) Int. Cl. G06F 40/30; G06F 40/205; G06Q 10/107; G06Q 20/10; G06V 20/62; G06V 30/10

(52) U.S. Cl. CPC G06F 40/30; G06F 40/205; G06Q 10/107; G06Q 20/10; G06V 20/62; G06V 30/10

(57) ABSTRACT

Provided is a system for implementing an automated system leveraging ML to classify, extract, and process payment-related documents. The system is designed to handle various document formats, including structured (e.g., EXCEL, CSV) and unstructured formats (PDFs and images). By developing and continuously training the ML model with a comprehensive set of labeled fields, the system can automatically recognize and extract the required data from incoming documents. This automation will replace the need for manual profiling of customer subscription fields and reduce the manual effort required to review and extract information from documents. The extracted data will be converted into a standardized format, allowing downstream application components to store and enrich the payment information effectively. The continuous enrichment of the ML model with new data ensures that the system adapts to evolving document types and content, thereby maintaining high accuracy and efficiency in data processing.

### CROSS-REFERENCE TO RELATED APPLICATION

This application claims priority to Indian Application No. 202511018500, filed Mar. 3, 2025, which is incorporated by reference herein in its entirety.

### FIELD OF TECHNOLOGY

The present disclosure relates generally to electronic automated systems that are enhanced by artificial intelligence (AI)/machine learning (ML) tools and AI/ML model training.

### BACKGROUND

Businesses often exchange payment-related documents, such as receipts, remittance advice, and invoices, in various formats, including emails and file uploads. Financial institutions that handle these documents face challenges in classifying this information, extracting information therefrom, and processing the diverse types of data formats ranging from structured formats (e.g., EXCEL™ and comma-separated values (CSV) text files) to unstructured formats (e.g., free-form, portable document format (PDF) and image).

Consequently, significant manual labor may be required to identify, map, and extract relevant data field information for input into an electronic payment processing system. Manual labor devoted to these tasks often results in inefficiencies, high operational costs, and errors. In connection with making a payment, a customer typically provides information in addition to the payment. For instance, an email message from the customer may provide a listing of items for which a payment is being made. This email message may document that the payment is in flight (e.g., the payment has been submitted) and detail additional payment information included with the payment submission.

The payment details and additional information may take the form of a structured document, such as an EXCEL™ file, or it may be an unstructured document, such as an image or picture of a receipt. Alternatively, payment information details may be in free form (a type of unstructured data) and appear anywhere in the body of an email message. A structured document may be defined as a document containing data that may fit neatly into data tables and include discrete data types such as numbers, short text, and dates. Unstructured data does conform to data table requirements. Unstructured data may include audio files, video files, or large text documents. The size or nature of these types of documents does not typically conform to a data table format.

### SUMMARY

Given the aforementioned deficiencies, a need exists to automate and streamline tasks such as collecting remittance details, including information about a payment flight or about a payment that has already been made, while providing a high degree of accuracy in identifying, extracting, and processing relevant information. Further, a need exists to enrich or provide more details from extracted information, such as remittance information that must be successfully extracted, with a high degree of accuracy from a message.

The present disclosure, through one or more of its various aspects, embodiments, and/or specific features or sub-components, provides, inter alia, various systems, servers, devices, methods, media, programs, and platforms for implementing a processing system for extracting data from electronic documents provided through an electronic communication system, but the disclosure is not strictly limited thereto. For example, the system may be used in connection with email document submissions as well as with documents uploaded online.

In one embodiment, a method for implementing a processing system for extracting data from electronic documents is provided through an electronic communication that includes receiving an email message over the electronic communication system; analyzing the email message and identifying structured and unstructured content in the email message; using one or more processors, identifying and extracting subject matter, in the email message, in accordance with a machine learning model, trained to identify and make inferences as to the content of the subject matter, the inferences being subject to a predetermined accuracy threshold; and storing the inferences, including inferences including directives to take action, in a database.

The method of any preceding clause, wherein the directives to take action include one or more remittances for payment.

The method of any preceding clause, wherein the inferences include financial account information for accessing an electronic account along with debit instructions for debiting an amount against the electronic account referenced in the financial account information.

The method of any preceding clause, further comprising: identifying and storing email documents including electronic attachments associated with each email message.

The method of any preceding clause, further comprising: storing the inferences and sending stored inferences, failing to meet the predetermined accuracy threshold, through processing for data perfection and correction using a method of lasso rubberbanding.

The method of any preceding clause, further comprising: presenting extracted data on a form displayed on a monitor screen associated with a UI for the processing system; manually selecting, for data perfection and correction, areas on the monitor screen, using a periphery device associated with the UI, the monitor screen areas corresponding to form fields; and implementing lasso rubberbanding in connection with the manually selecting of monitor screen areas.

The method of any preceding clause, further comprising: imaging each email document; processing each email document, by the one or more processors, according to one or more image processing techniques, in conjunction with the use of the ML model to make the inferences using image identification.

The method of any preceding clause, further comprising: processing each email document in conjunction with the use of the ML model to make inferences according to an LLM.

The method of any preceding clause, further comprising: saving metadata meeting a predetermined accuracy threshold, the metadata being associated with perfecting extracted remittance information; and using the metadata, meeting the accuracy threshold, to further train the ML model.

Another embodiment includes a method accomplished using one or more processors, comprising: polling for unread email messages and for each email transaction: storing email receipt details in a remittance database configured to store remittance information; storing email documents in cloud-based storage; extracting attachments to each email messages; compressing the attachments; imaging each page of an email document; parsing text from each page of the imaged email document; extracting remittance information from each page of the imaged email document according to an machine language model trained to recognize remittance information; determining whether extracted remittance information meets a predetermined threshold of accuracy; and perfecting extracted remittance information that does not meet the predetermined threshold of accuracy, according to a method of data perfection using lasso rubberbanding.

The method of any preceding clause, further comprising: storing selected remittance information storage comprising a cloud-based storage container and a database configured to hold remittance information.

The method of any preceding clause, wherein perfecting the extracted remittance information that does not meet the predetermined threshold of accuracy, includes subjecting selected areas of a UI interface to lasso rubberbanding.

The method of any preceding clause, further comprising saving metadata, meeting an accuracy threshold, associated with perfecting extracted remittance information; and using the metadata, meeting the accuracy threshold, associated with the perfected extracted remittance information to further train the ML model.

In another embodiment, a system for implementing a processing system for extracting data from electronic documents is provided that includes: a database for storing partnering applications; a profile definition collector to provide subscriber profiles; a document classifier; a data extractor for extracting data using a machine learning model; an extracted data perfector for perfecting data received from the data extractor not meeting a predetermined accuracy threshold; and a database in which extracted and perfected data is published.

The system of any preceding clause, wherein the document classifier is configured to classify a document according to a selection from the group consisting of a structured document, an unstructured document, and a freeform document.

The system of any preceding clause, further comprising a trainer, the trainer being configured to continuously train the machine language model in conjunction with using metadata from the extracted data perfector

In other embodiments, a non-transitory computer-readable medium configured to store instructions for implementing a processing system for extracting data from electronic documents is provided. When executed, the instructions cause a processor to perform the following: poll for unread email messages and for each email transaction: cause email receipt details to be stored in a remittance database configured to store remittance information; cause email documents to be stored in cloud-based storage; extract attachments to each email messages; compress the attachments; image each page of an email document; parse text from each page of the imaged email document; extract remittance information from each page of the imaged email document according to a machine language model trained to recognize remittance information; determine whether extracted remittance information meets a predetermined threshold of accuracy; and perfect extracted remittance information that does not meet the predetermined threshold of accuracy, according to a method of data perfection using lasso rubberbanding.

The non-transitory computer readable medium of any preceding clause, wherein extracted remittance information that does meet the predetermined threshold of accuracy is published to a document database.

The non-transitory computer readable medium of any preceding clause, wherein, the electronic documents comprise data selected from the group consisting of structured data, unstructured data, freeform data, and combinations thereof.

The non-transitory computer readable medium of any preceding clause, the instructions further causing the processor to cause metadata, meeting an accuracy threshold, to further train the ML model.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for the purpose of illustrating the embodiments and are not to be construed as limiting the disclosure. Given the following enabling description of the drawings, the novel aspects of the present disclosure should become evident to a person of ordinary skill in the relevant art(s).

FIG. 1 is a block diagram of a system showing a process flow for implementing a processing system, including aspects of a straight through processing system, (STP) which leverages ML technology to classify, extract and process payment-related documents.

FIG. 2 illustrates a diagram detailing a higher-level aspect of the system and process flow of the automated system shown in FIG. 1.

FIGS. 3A-3D illustrate an extended process workflow of an embodiment of the processing system.

FIG. 3E illustrates a sketch of a user interface (UI) screen that reflects aspects of the function of data perfection.

FIG. 3F illustrates a sketch of the lasso rubberbanding procedure/results in connection with perfecting data extraction.

FIGS. 3G and 3H illustrate simplified flow charts covering a process flow for STP.

FIGS. 4 through 7 are workflow diagrams illustrating an embodiment of a remittance processing system for handling email-based transactions.

FIG. 8 illustrates an environment in which various embodiments may be implemented.

Reference numerals have been carried forward.

### DETAILED DESCRIPTION

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process steps, order of process step execution and omission of certain disclosed process steps may be made without departing from the scope of the present disclosure.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As described herein, various embodiments provide various systems, servers, devices, methods, media, programs, and platforms for collecting evidence details collected from a variety of sources. These evidence details may relate to remittance payments submitted through a computer processing system. Such evidence details may include remittance information that may potentially enrich basic remittance data by, for instance, providing more detailed information concerning a payment.

The remittance payments may represent receivables for a wide variety of types, such as payments for mortgage debt. In particular, the evidence details may pertain to payments currently being submitted to an electronic payment processing system or the evidence details may pertain to payments already previously processed by an electronic payment processing system.

A remittance payment may be submitted by a variety of payment methods/communications, such as by online uploads, electronic mail (e-mail or email), electronic form submissions or other correspondence. As such, remittance information must be extracted from these communications. Consequently, the desired information for extraction may be in a variety of different formats.

The present disclosure provides a solution to the foregoing problems related to manual labor functionality by introducing an automated system leveraging ML technology to classify, extract, and process payment-related documents. Per classifying documents, the system is able to classify documents as being either structured or unstructured. The system is designed to handle various document formats including structured and unstructured formats.

An AI model may be developed and continuously trained using information identified according to a comprehensive set of labeled fields. These fields may include, for instance, the following: invoice number, invoice amount, and invoice date. As a result of the ML, the automated system can automatically recognize and extract required data from incoming documents. This automation may eliminate the need to manually profile customer subscription fields and it reduces the manual effort required to review and extract data from documents.

The system disclosed herein may extract and convert extracted data to a standardized format. A standardized format facilitates the storage of data and aids in providing effective data mining from documents. The continuous training of the ML model with new data passing through the system provides the payment system with the ability to adapt to evolving document types and document content. As a result, data integrity may be maintained at a high level of accuracy, and data processing may be performed with a high degree of efficiency.

The solution disclosed herein offers significant advantages including the reduction of manual intervention, leading to lower operational costs and reduced labor headcount. It also minimizes human errors, thereby enhancing data accuracy and quality. Through automation of the tasks outlined herein, straight-through processing (e.g., automatic processing) may be accomplished, resulting in high efficiency and low turnaround times for data processing.

The systems'ability to handle various document formats ensures higher enrichment and association success rates over that of systems currently in use in the marketplace. The system may help facilitate increased revenue for financial institutions by streamlining payment processing, leading to enhanced customer satisfaction.

As described herein, various embodiments provide various systems, servers, devices, methods, media, programs, and platforms for implementing an automated system leveraging ML technology to classify, extract and process payment-related documents

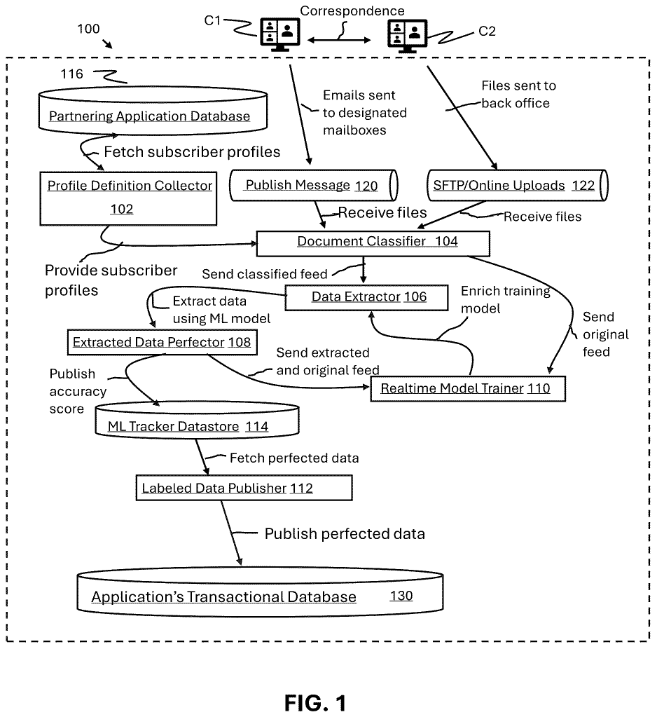

FIG. 1 is a block diagram of system 100 showing a process workflow for implementing a processing system. The system 100 includes aspects of an STP system, which leverages ML technology to classify, extract, and process payment-related documents. STP refers to a system that uses electronic transfers to automate financial transactions without the need for manual intervention.

As illustrated in FIG. 1, according to an exemplary use case (e.g., an electronic remittance system), system 100 may include several functional blocks, implemented in software or implemented using a combination of software with hardware, for providing an electronic remittance system (hereinafter referred to as an e-remittance system). The embodiment shown in FIG. 1 for system 100 is particularly well-suited for handling data uploaded online.

The system of FIG. 1 includes Profile Definition Collector 102 coupled to Document Classifier 104. Document Classifier 104 is coupled to Data Extractor 106. Extracted Data Perfector 108 is coupled to Realtime Model Trainer 110, which is coupled to Data Extractor 106 and Document Classifier 104. Labeled Data Publisher 112 is coupled to Extracted Data Perfector 108 through ML Tracker Datastore 114. Profile Definition Collector 102, being further coupled to Partnering Application Database 116, serves to collect customer-subscribed parameters from Partnering Application Database 116.

As demonstrated by the process flow shown in FIG. 1, C1, which represents a payment service representative, may receive correspondence (e.g., electronic correspondence), during an exchange of information, including remittance information from C2, which represents a customer or subscriber. Messages exchanged between C1 and C2 are sent to a designated electronic mailbox and thereby published at step 120.

Further, files sent online from C2 (and thereafter directed, for instance, to a back office) pursuant to payment processing by system 100 may be uploaded to secure file transfer protocol (SFTP) server 122. Messages published at step 120 are provided in files and received by Document Classifier 104. Document Classifier 104 also receives files from SFTP server 122. Document Classifier 104 classifies incoming files as structured or unstructured and pins the files to customer/subscriber profiles in connection with receiving customer/subscriber profile information from Profile Definition Collector 102.

As used herein, customer and subscriber may be used herein, interchangeably. Document Classifier 104 feeds data, classified as structured or unstructured, (and pinned to associated customers) to Data Extractor 106. Data Extractor 106 employs an ML model to extract data fed from and classified by Document Classifier 104. The extracted data is sent to Extracted Data Perfector 108, which may perfect data not successfully extracted by Data Extractor 106.

An accuracy score reflects the accuracy of the data extraction. The accuracy score is published in the ML Tracker Datastore. The accuracy score also reflects the accuracy of inferences made by the ML model. System 100 may set a threshold for accuracy which the accuracy score must reflect in order for data to be considered properly extracted. Failure to meet this threshold may cause processing to divert from STP to processing which requires manual intervention.

Consequently, should some aspects of data extraction for a transaction fail, the information (file, email, etc.) holding the perceived non-extracted data may be passed to a UI where an operator may manually inspect or use point-and-shoot methods at a UI in an effort to achieve a successful data extraction.

The point-and-shoot methods may be carried out in conjunction with using a periphery device (not shown) associated with the UI, such as a computer mouse, electronic scanner, electronic stylus, etc., to make selections. These point-and-shoot methods select coordinates of a region of interest (e.g., field region) shown on the screen of a UI for operator-assisted validation. The region of interest is then subjected to image processing for character recognition. Metadata therefrom may be sent to the ML model in order to provide additional training for the ML model

Rubber band OCR is an OCR tool that permits a user of the tool to capture data field information, on-screen, without having to manually enter the data. The optically recognized data is then populated into a corresponding data field for which the data is sought. The capture of data on-screen may be further facilitated using a lasso tool rubber band. The lasso tool rubber band presents a visual dynamic line on a computer screen that follows a user's computer mouse movements as a freehand boundary is drawn around an object or objects for capture. The computer screen displays the boundary around the object(s) selected for character recognition and the term rubberbanding refers to the drawn line path as it stretches and moves with a cursor in a fashion similar to that of a rubber band.

The boundary drawn around objects with the lasso tool rubber presents a mask, the edges of which are defined by user mouse movements using mouse controls. The lasso tool creates a temporary active layer containing the logical AND of the masking layer and the active image layer. The lasso tool also masks (logically ANDs) the original active layer with the inverse of the screen selection. The tool causes the display of that which appears as a sliced-out segment from the original image. An extracted segment may then populate a corresponding field for display on a monitor screen. With rubberbanding, the validation and the attendant coordinates of a region of interest are remembered or learned. The validation and region of interest may serve as a template to further train and enrich the ML model which may employ standard natural language processing using weighted analysis.

The additional and/or continuous training for the ML Model may be accomplished in connection with Data Extractor 106 receiving data from Realtime Model Trainer 110. Realtime Model Trainer 110 uses extracted data to enrich and improve the ML model. Realtime Model Trainer 110 receives both an original feed of data from Document Classifier 104 as well as the extracted and original feed from Extracted Data Perfector 108.

Data from ML tracker Datastore 114 may be fetched by Labeled Data Publisher 112. Labeled Data Publisher 112 publishes perfected data to subscribing applications in Application's Transactional Database 130. Perfected data, as used herein, refers to data that is intended to be free from errors and inconsistencies prior to training an ML model. Data perfection may include making sure there are no missing values in fields, ensuring data formatting is consistent, verifying records are not duplicated, removing obvious data errors (such as values that are not possible), and providing text in a standardized format.

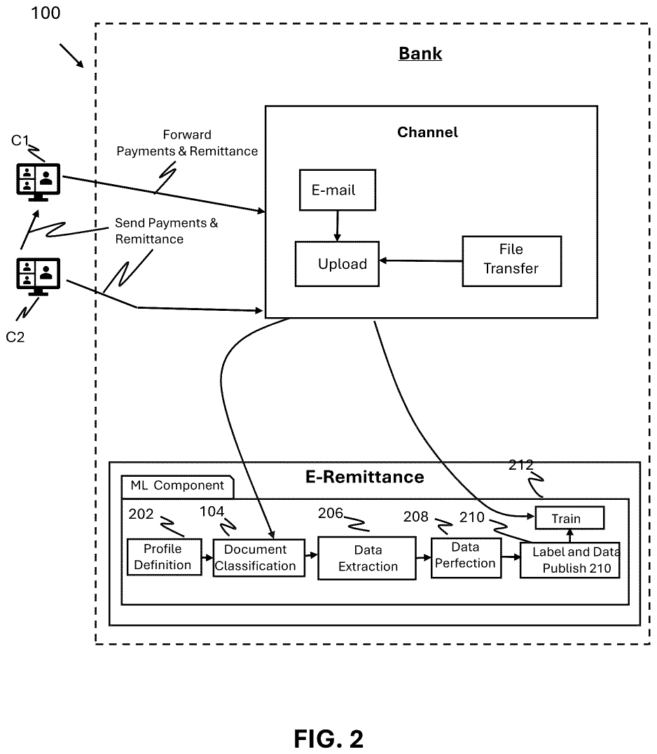

FIG. 2 illustrates a diagram detailing a higher-level aspect of the system and process flow of the system shown in FIG. 1. The system outlined in FIG. 2 may orchestrate, classify, queue, and extract data automatically. In one embodiment, the system depicted in FIG. 2 may be particularly well-suited for use at a bank. The source of remittance information for a transaction may be varied. It may appear via a website, in e-mail correspondence, a voice-to-text message, or submitted on a form such as by file transfer.

As shown, information may be uploaded, for instance, in conjunction with a text-to-text transfer transformer (T5 transfer) which refers to a series of commonly used large language models using an encoder to process input text and a decoder to generate output text. Consequently, and in some cases via T5 transfer, payment service representative C1 may forward payments and electronic remittances (e-remittances), received electronically from customer C2, through a communication channel for upload to system 100. Alternatively, customer C2 may forward payments and e-remittances directly to system 100 via a communication channel in conjunction with, for instance, a T5 transfer.

The e-remittance portion of the ML component of system 100 includes performing the following steps: defining a profile (Profile Definition 202 as sourced from Profile Definition Collector 102 of FIG. 1); classifying documents according to being structured or unstructured (Document Classification 104); extracting relevant remittance information from data provided over the Channel (Data Extraction 206 in conjunction with Data Extractor 106 of FIG. 1); perfecting the data (Data Perfection 208); and labeling and publishing the data to Application's Transactional Database 130 of FIG. 1 (Label and Data Publish 210). Further, data for training (Train 212) of the ML model is delivered through the Channel.

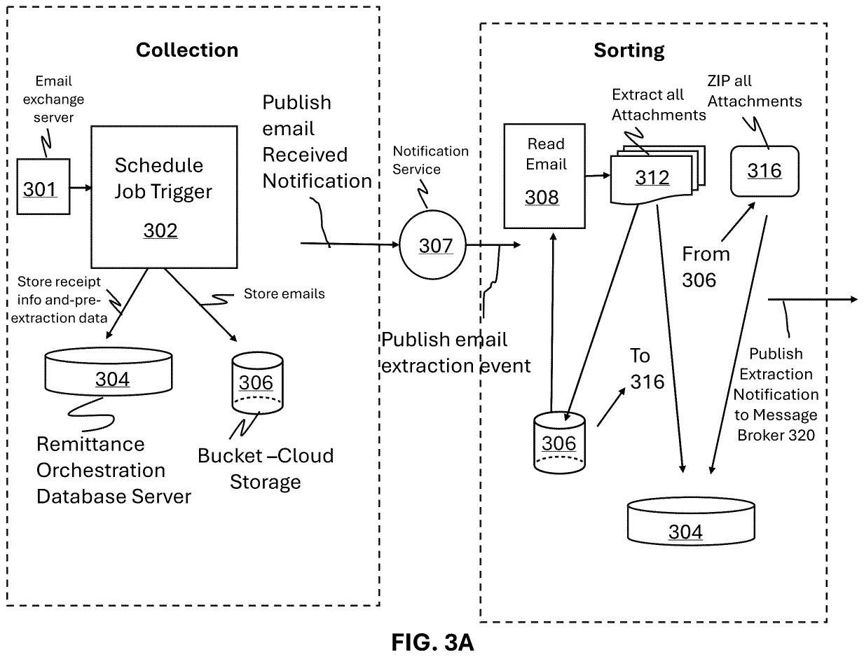

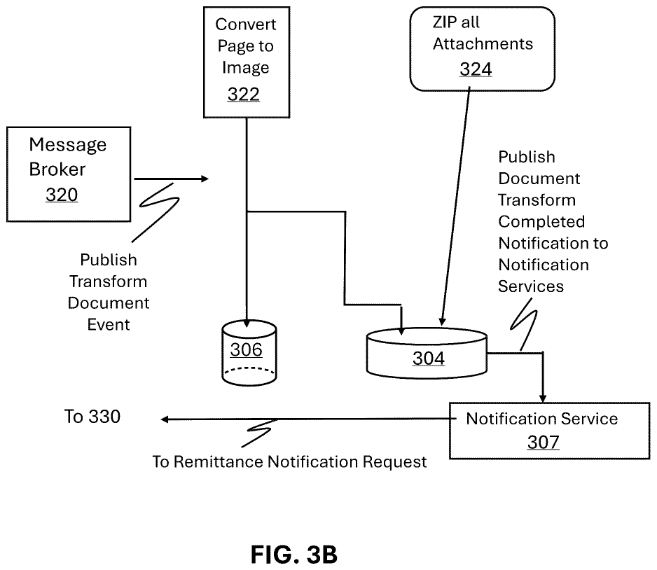

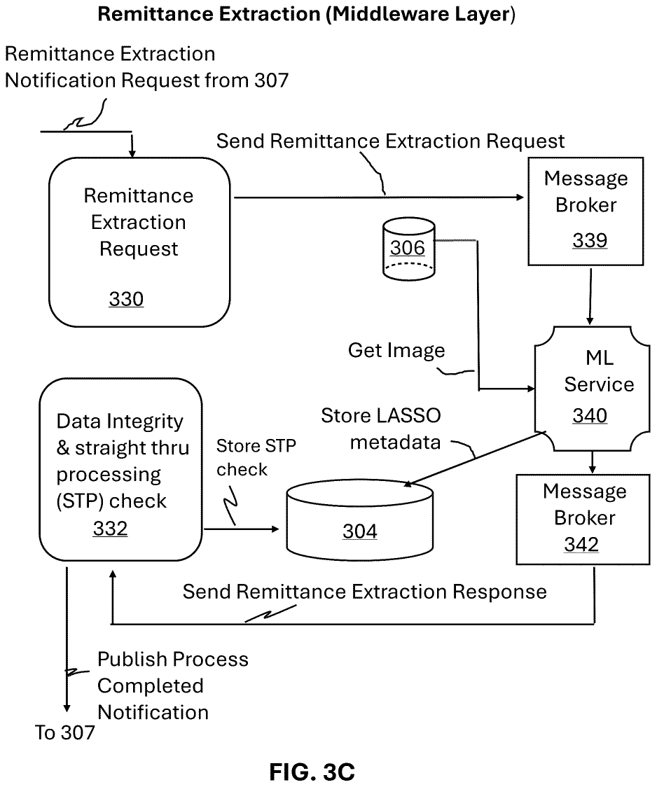

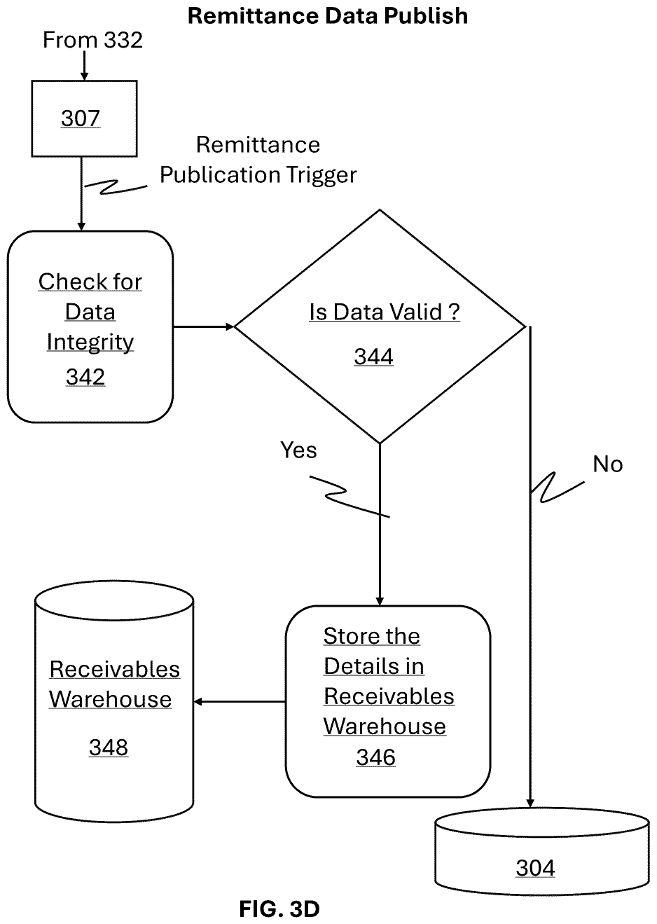

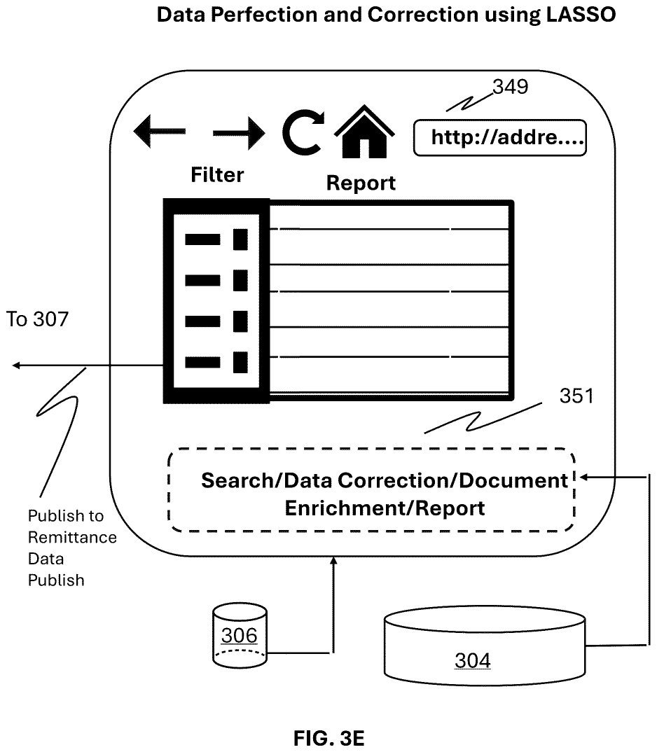

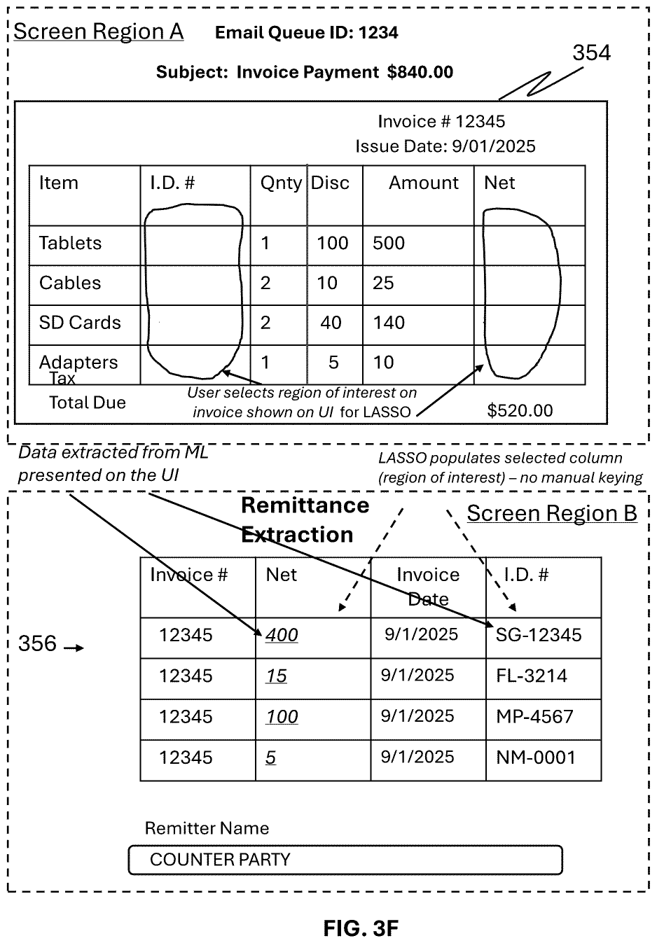

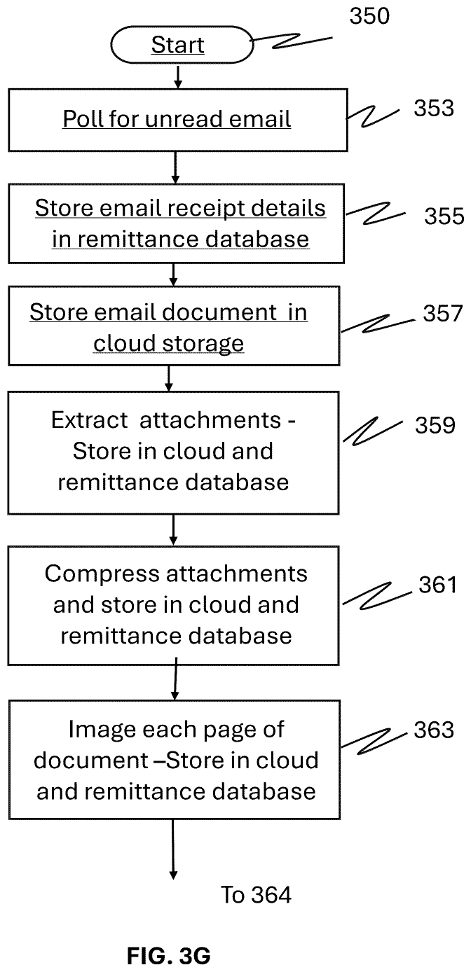

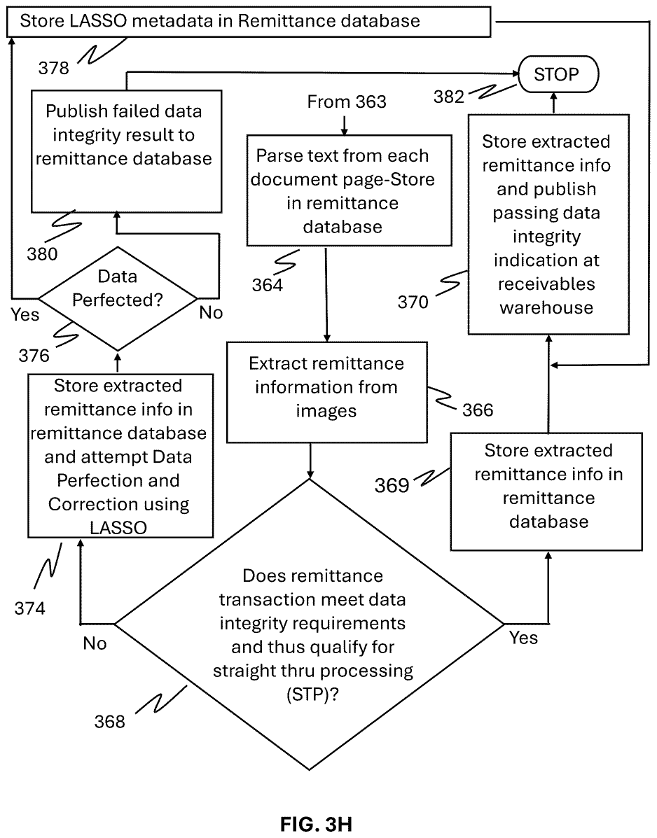

FIGS. 3A-3D illustrate an extended process workflow of an embodiment of the processing system according to the disclosure herein. With reference to FIG. 3A, collection and sorting are accomplished in connection with scheduling the processing of a financial transaction by Schedule Job Trigger 302, a software function executed by a processor implementing processing system 100 (FIGS. 1 and 2).

The processing begins with a Collection Phase entailing Remittance Orchestration Database Server 304 receiving and storing email receipt information received by the processing system. The email may be received via Email Exchange Server 301 in connection with polling for unread mail. Processing of an email for retrieving remittance information may begin with the job trigger, followed by marking the email as read in Exchange Server 301.

The email receipt information may include the date and time of receipt of the email, sender identification information, etc. Received emails are stored in Bucket 306 which may represent a cloud container storage such as an Amazon S3 bucket. Received email notifications are published to Email Notification Service 307 (such as an Amazon Simple Notification Service (SNS)) which also publishes the extraction event.

The extraction event is part of the Sorting Phase, such event entailing reading an email retrieved from Bucket 306 (step 308); extracting attachments (step 312) and placing them in Bucket 306; and compressing (step 316) all attachments (such as via ZIP, a well-known file format compression) received from Bucket 306 and storing the compressed attachments in Orchestration Database Server 304. Extracted email attachments are stored in Bucket 306 and Orchestration Database Server 304.

With reference to FIGS. 3A and 3B, an extraction notification is published to Message Broker 320. Message Broker 320 represents software that translates messages between formal messaging protocols to enable systems, applications, and services to communicate with one another and exchange information.

With reference to FIG. 3B, Message Broker 320 publishes a document page transform event to Bucket 306 in connection with each page of a document being converted to an image by image processing software carried out by a processor (not shown) associated with system 100 (FIGS. 1 and 2). Images are compressed (e.g., placed in associated ZIP files) at step 324 in connection with software processing. The compressed images are stored, along with their non-compressed images in Remittance Orchestration Database Server 304.

FIG. 3C illustrates the Remittance Extraction phase of the system, disclosed herein, which accomplishes the middleware layer of software implementing processing system as disclosed herein. Notification Services 307 publishes the completion of the document transformations and sends a remittance extraction request 330 to Message Broker 339.

ML Service 340 employs artificial intelligence methods using machine learning to extract meaningful information from document images received from Bucket 306 through image processing using a combination of image processing techniques as performed on one or more processors associated with system 100 (FIGS. 1 and 2).

Extracted remittance information is sent through a data integrity check as well as for STP verification at step 332. The data integrity check may include ensuring that the accuracy score associated with an ML extraction meets a predetermined threshold. If not, such does not qualify for STP. At this juncture, a lasso tool employing rubberbanding may be used to perfect data that has not been successfully extracted.

The indication of whether the data extraction qualifies for STP is noted in Remittance Orchestration Database Server 304. Should the data perfection be successful, the metadata associated with the data perfection is stored in Remittance Orchestration Database Server 304 as well. This metadata may be used to further train the AI model to improve ML associated with system 100 (FIGS. 1 and 2). A process-completed notification is published to Notification Service 307.

FIG. 3D illustrates the Remittance Data Publish phase of the system disclosed herein. After a publish process completed notification is received by notification service 307 in connection with an indication of successful data integrity (step 342) qualifying for STP (step 344) from the Remittance Extraction phase, this results in a remittance publication trigger. Software logic notes the data integrity of a data extraction (step 346) including the data validity. Successfully extracted remittance information is stored in Receivables Warehouse 348. Unsuccessfully extracted remittance data is stored in Remittance Orchestration Database Server 304.

FIG. 3E illustrates a sketch of a UI screen that reflects aspects of the function of data perfection. A web address (as indicated by the URL bar 349) allows the selection of documents stored in Bucket 306, etc., and may be manipulated using on-screen icons (arrows, returns, report macro buttons, etc.). Search, data corrections, document enrichment, and reporting (as represented as functionality 351) may be carried out in connection with UI commands, which may ultimately result in the publication of remittance data to Notification Service 307.

“Service” as used herein may be used interchangeably with “microservice” to describe a software process, software application, application programming interface, and the like that provide particular functionalities such as communication and access to one or more computing resources, computing functionalities, and or computing systems.

FIG. 3F illustrates a sketch of the lasso rubberbanding procedure/results in connection with perfecting data extraction. As shown, a user may select a column of information from region 354 that is not displayed on extracted data Screen Region A. The selection enables lasso rubberbanding of these displayed columns. This aspect is shown in the perfected columns of data displayed in Screen B on region 356.

FIGS. 3G and 3H illustrate simplified flow charts covering a process flow for STP processing that can be adapted to include handling an exception to attempt data perfection requiring minimal human intervention. The process starts at step 350. A poll is taken for unread email at step 353.

At step 355, the email receipt details are stored. At step 357, each document being processed is stored in cloud storage such as an Amazon S3 bucket. At step 359, attachments are extracted and stored in the cloud (S3 bucket, etc.) and in a remittance database.

At step 361, the attachments are compressed and stored in the cloud and in the remittance database. At step 363, each page of a document is imaged and stored in the cloud and in the remittance database. Text is parsed from each document page and stored in the remittance database at step 364.

Remittance information is extracted from each image at step 366. At step 368, a decision is made whether the remittance transaction meets data integrity requirements and thereby qualifies for STP. This may include a determination as to whether an accuracy score for an ML result is above a given threshold. For data extraction that meets data integrity requirements, the extracted remittance information is stored in the remittance database at step 369.

Thereafter, it is stored in the receivables warehouse, a data warehouse for holding structured and semi-structured data from various sources. The passing data integrity indication is also stored at the receivable warehouse. For an extraction that does not meet data integrity standards, at step 374, the remittance information is stored in the remittance database, and data perfection and correction are attempted using lasso rubberbanding.

At decision at step 376 a determination is made as to whether the data perfection is successful. If the data perfection is successful, then metadata produced from the OCR result using the lasso tool is stored in the remittance database at step 378, and it may be used to further train the ML model. Thereafter the extracted remittance info and the passing data integrity indication are stored in the receivables warehouse. The process flow ends at step 382.

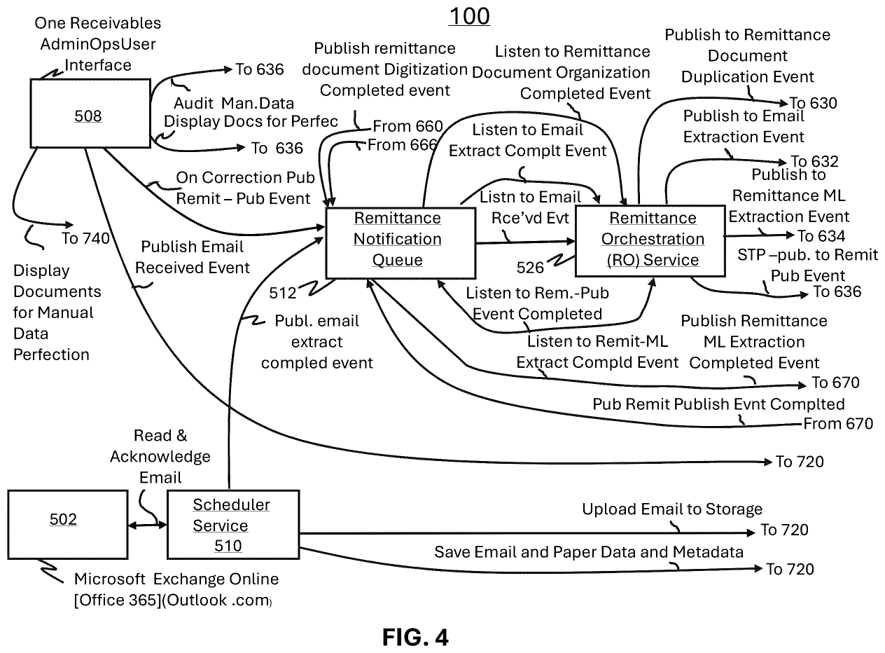

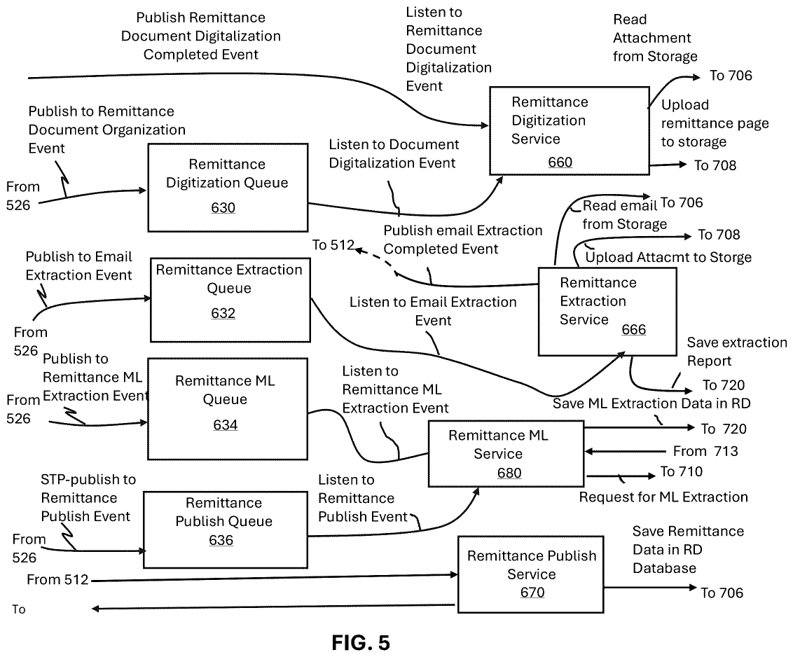

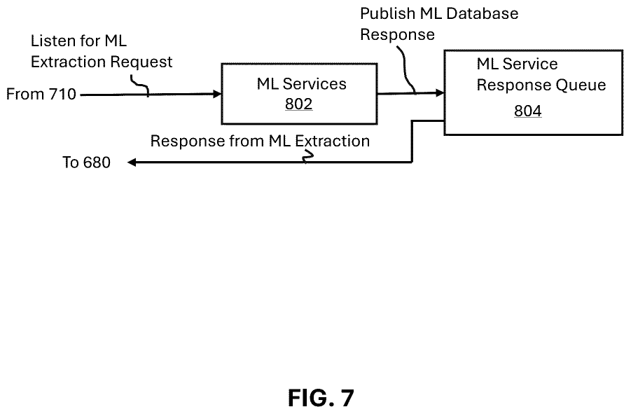

FIGS. 4 through 7 are workflow diagrams illustrating an embodiment of a remittance processing system 100 for handling email-based transactions. The embodiment of system 100 shown in FIGS. 4 through 7 captures emails, extracts attachments, extracts information including remittance information, classifies information, and publishes documents.

FIGS. 4 through 7 detail the interactions among several database containers-data structures that store and organize data for use across multiple computer systems. Flow steps are placed in queues and executed according to dedicated functions. Exchange Server 502 (e.g., Microsoft® Exchange Online, etc.) provides email server needs for system 100.

Exchange Server 502 is coupled to Scheduler Service 510 through which email and acknowledgements are exchanged. Scheduler Service 510 sends a publication email extraction completed event notification to Remittance Notification Queue 512 upon the extraction of an email message from Exchange Server 502.

Remittance Orchestration (RO) Service 526 listens for an email received event notification from Remittance Notification Queue 512. Remittance Orchestration (RO) Service 526 publishes the following: an email extraction event to Remittance Extraction Queue 632; a remittance document organization event notification to the Remittance Digitization Queue 630 to provide digital processing for message content (compression, format conversion, etc.); and a remittance ML extraction event notification to Remittance ML Queue 634 to start remittance information extraction from a message.

Remittance ML Service listens for a remittance ML extraction event notification from Remittance ML Queue 634. Remittance ML Service 680 sends a request for ML extraction of email remittance information to ML Service Request Queue 710. ML Service Request Queue 711 listens for an ML service extraction request and publishes an ML extraction response to ML Service Response Queue 713.

ML Service Response Queue 713 sends the ML extraction response to Remittance ML Service 680. Remittance ML Service 680 sends the ML extraction data to Document Database 720, where this information is saved. Further, reports, status, emails, invoice data, and metadata may be stored in Document Database 720.

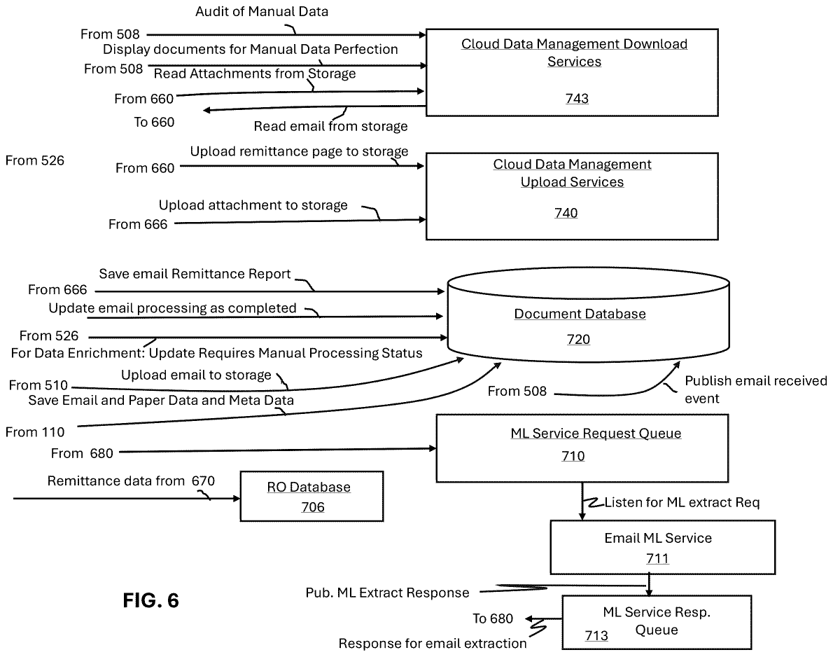

For instance, as shown in FIG. 6, Document Database 720 may receive the following: email remittance Reports, notifications of completion of updated email processing, manual processing status updates pursuant to data enrichment (e.g., data perfection), email remittance instructions, paper data, metadata, etc.

Publication of email remittance information is orchestrated by RO Service 526, which publishes an STP remittance publication event through Remittance Publication Queue 636.

Remittance Publication Service 670 saves remittance data in RD Database 706. Remittance Extraction Service 666 uploads attachments and reads emails to cloud storage. It also saves an extraction report to Document Database 720. Cloud Data Management Upload Services 740 may upload transaction remittance page information and attachments for storage.

A request for the information uploaded to Cloud Data Management Upload Services 740, may be made to Cloud Data Management Download Services 743. Such a request may be for the purpose of downloading attachments or data for display on a user terminal integrated with AI and ML, such as ONE receivables interface 508.

Thereafter, the ONE Receivables terminal user may attempt to perfect data in connection with efforts to extract data, (e.g., attain a better accuracy score in data extraction) or accomplish an audit of manual data. This may permit the rubberbanding techniques, such as lasso rubberbanding, as disclosed herein.

One Receivables interface 508, may also publish the receipt of an email at Document Database 720. Further, the notification of the manual correction of data may be forwarded to the Remittance Notification Queue for publication by Remittance Publishing Service 670. The corrected data may be saved in Remittance Orchestration database 706.

Machine learning data extraction of email content may be accomplished by ML Services 802 in connection with listening for an extraction request received through ML Service Request Queue 710. Once the extraction occurs, the ML extraction response is published through the ML Service Response Queue, and the email extraction is sent to Remittance ML Service 680. The extracted email data is saved in the Remittance Orchestration database 706.

AI and/or ML models referenced herein may make use of techniques using LLMs, natural language processing (NLP), and image processing.

The foregoing embodiments reflect extraction of data from documents. This may occur in connection with an STP or in connection with a limited degree of human interaction, that may result in data being perfected. Processing of data may be documented, classified, tracked, and stored at various stages and provided with an accuracy score in an effort to extract relevant information.

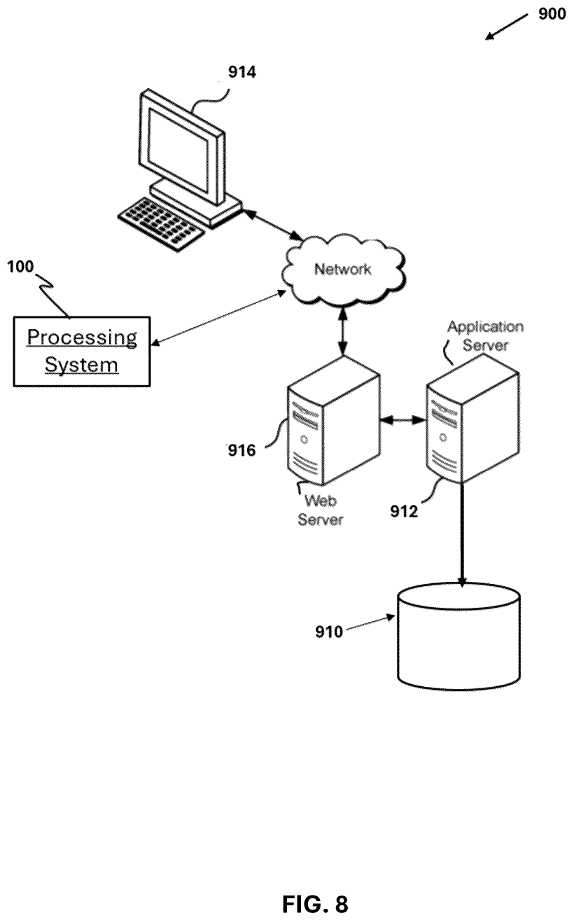

FIG. 8 illustrates an environment in which various embodiments may be implemented. This illustrative environment, such as example environment 900, may include, for instance, at least one application server 902 and a data store 910. Data store 910 may be implemented through the use of databases, database containers, computer memories, etc.

It should be understood that there can be several application servers, layers, or other elements, processes, or components, that may be chained or otherwise configured. These components can interact to perform tasks such as obtaining data from an appropriate data store.

Servers, as used herein, may be implemented in various ways, such as hardware devices or virtual computer systems. In some contexts, servers may refer to a programming module being executed on a computer system.

As used herein, unless otherwise stated or clear from context, the term “datastore” or “data store” refers to any device or combination of devices capable of storing, accessing, and retrieving data, which may include any combination and number of data servers, databases, data storage devices, and data storage media, in any standard, distributed, virtual, or clustered environment.

Application Server 912 may include any appropriate hardware/software/firmware for integrating with the Data Store 910 needed to execute aspects of applications for Client Device 914, handling some or all of the data access and logic for an application. Application Server 912 may provide access control services in cooperation with the Data Store 910.

Application Server 912 may also generate content including, but not limited to, text, graphics, audio, video, and/or other content usable to be provided to the user. Such content may be served to the user by Web Server 916 in the form of Hypertext Markup Language (“HTML”), Extensible Markup Language (“XML”), JavaScript, Cascading Style Sheets (“CSS”), JavaScript Object Notation (JSON), and/or another appropriate client-side structured language.

Content transferred to Client Device 914 may be processed by client device 914 to provide the content in one or more forms including, but not limited to, forms that are perceptible to the user audibly, visually, and/or through other senses. The handling of all requests and responses, as well as the delivery of content between the Client Device 914 and Application Server 912, may be handled by Web Server 916 using PHP:

Hypertext Preprocessor (“PHP”), Python, Ruby, Perl, Java, HTML, XML, JSON, and/or another appropriate server-side structured language in this example. Further, operations described herein as being performed by a single device may, unless otherwise clear from context, be performed collectively by multiple devices, which may form a distributed and/or virtual system.

The environment, in one embodiment, is a distributed and/or virtual computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 8. Thus, the depiction of the system illustrated in the example environment 900 in FIG. 8 should be taken as being illustrative in nature and not limiting to the scope of the disclosure.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software may instruct the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as is necessary and/or desirable.

Also, the instructions and/or data used in the practice of the foregoing may utilize any compression or encryption technique or algorithm, as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium.

That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the foregoing.

Further, the memory or memories used in the processing machine that implements the foregoing may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

Additionally, various technologies may be used to provide communication between the various processors and/or memories, as well as to allow the processors and/or the memories of the foregoing to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As will be appreciated, although a web-based environment is used for purposes of explanation, different environments may be used, as appropriate, to implement various embodiments. The environment including client device 914, may include any appropriate device operable to send and/or receive requests, messages, or information over an appropriate network 906. In some embodiments, an appropriate device may convey information back to a user of the device. Examples of such client devices 914 include personal computers, cell phones, handheld messaging devices, laptop computers, tablet computers, set-top boxes, personal data assistants, embedded computer systems, electronic book readers, and the like.

Although the present application describes specific embodiments that may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for implementing a processing system for extracting data from electronic documents provided through an electronic communication system, comprising:
receiving an email message over the electronic communication system;
analyzing the email message and identifying structured and unstructured content in the email message;
using one or more processors, identifying and extracting subject matter, in the email message, in accordance with a machine learning (ML) model, trained to identify and make inferences as to the content of the subject matter, the inferences being subject to a predetermined accuracy threshold; and
storing the inferences, including inferences including directives to take action, in a database.

2. The method according to claim 1, wherein the directives to take action include one or more remittances for payment.

3. The method according to claim 1, wherein the inferences include financial account information for accessing an electronic account along with debit instructions for debiting an amount against the electronic account referenced in the financial account information.

4. The method according to claim 1, further comprising: identifying and storing email documents including electronic attachments associated with each email message.

5. The method according to claim 4, further comprising: storing the inferences and sending stored inferences, failing to meet the predetermined accuracy threshold, through processing for data perfection and correction using a method of lasso rubberbanding.

6. The method according to claim 5, further comprising:
presenting extracted data on a form displayed on a monitor screen associated with a user interface (UI) for the processing system;
manually selecting, for data perfection and correction, areas on the monitor screen, using a periphery device associated with the UI, the monitor screen areas corresponding to form fields; and
implementing rubberbanding in connection with the manually selecting of monitor screen areas using a lasso tool.

7. The method according to claim 6, further comprising:
imaging each email document; and
processing each email document, by the one or more processors, according to one or more image processing techniques, in conjunction with the use of the ML model to make the inferences using image identification.

8. The method according to claim 7, further comprising: processing each email document in conjunction with the use of the ML model to make inferences according to a large language model (LLM).

9. The method according to claim 7, further comprising: saving metadata meeting a
predetermined accuracy threshold, the metadata being associated with perfecting extracted remittance information; and
using the metadata, meeting the accuracy threshold, to further train the ML model.

10. A method accomplished using one or more processors, comprising:
polling for unread email messages and for each email transaction:
storing email receipt details in a remittance database configured to store remittance information;
storing email documents in cloud-based storage;
extracting attachments to each email messages;
compressing the attachments;
imaging each page of an email document;
parsing text from each page of the imaged email document;
extracting remittance information from each page of the imaged email document according to an machine language model trained to recognize remittance information;
determining whether extracted remittance information meets a predetermined threshold of accuracy; and
perfecting extracted remittance information that does not meet the predetermined threshold of accuracy using lasso rubberbanding.

11. The method according to claim 10, further comprising: storing selected remittance information storage comprising a cloud-based storage container and a database configured to
hold remittance information.

12. The method according to claim 11, wherein perfecting the extracted remittance information that does not meet the predetermined threshold of accuracy, includes enclosing selected areas of a UI display to a lasso rubberband.

13. The method according to claim 12, further comprising;
saving metadata, meeting an accuracy threshold, associated with perfecting extracted remittance information; and using the metadata, meeting the accuracy threshold, associated with the perfected extracted remittance information to further train the ML model.

14. A system for implementing a processing system for extracting data from electronic documents, the system comprising:
a database for storing partnering applications;
a profile definition collector for receiving subscriber profiles from the database;
a document classifier, configured to receive subscriber profiles from the profile definition collector,
a data extractor, coupled to the profile definition collector and configured to extract data using a machine learning model;
an extracted data perfector for perfecting data received from the data extractor not meeting a predetermined accuracy threshold; and
a database for which publication of extracted and perfected data is published.

15. The system according to claim 14, wherein the document classifier is configured to classify a document according to a selection from the group consisting of a structured document, an unstructured document, and a freeform document.

16. The system according to claim 14, further comprising a trainer, the trainer being configured to continuously train the machine language model in conjunction with using metadata from the extracted data perfector.

17. A non-transitory computer readable medium configured to store instructions for implementing a processing system for extracting data from electronic documents, wherein, when executed, the instructions cause a processor to perform the following:
poll for unread email messages and for each email transaction:
cause email receipt details to be stored in a remittance database configured to store remittance information;
cause email documents to be stored in cloud-based storage;
extract attachments to each email messages;
compress the attachments;
image each page of an email document;
parse text from each page of the imaged email document;
extract remittance information from each page of the imaged email document according to an machine language model trained to recognize remittance information;
determine whether extracted remittance information meets a predetermined threshold of accuracy; and
perfect extracted remittance information that does not meet the predetermined threshold of accuracy, using a lasso rubberband.

18. The non-transitory computer readable medium according to claim 17, wherein, extracted remittance information that does meet the predetermined threshold of accuracy is published to a document database.

19. The non-transitory computer readable medium according to claim 17, wherein, the electronic documents comprise data selected from the group consisting of structured data, unstructured data, freeform data, and combinations thereof.

20. The non-transitory computer readable medium according to claim 17, the instructions further causing the processor to cause metadata, meeting an accuracy threshold, to further train the ML model.
